(19) United States
(12) Patent Application Publication
(10) Pub. No.: US 2011/0122753 A1
(43) Pub. Date: May 26, 2011

(54) METHOD FOR DETERMINING FOCUS HEIGHT

(75) Inventors: Chun-Yang Hou, Taoyuan County (TW); Yi-Long Hsiao, Taoyuan County (TW)

(73) Assignee: QUANTA STORAGE INC., Taoyuan County (TW)

(21) Appl. No.: 12/892,611

(22) Filed: Sep. 28, 2010

(30) Foreign Application Priority Data
Nov. 24, 2009 (TW) 098140086

(51) Int. Cl. G11B 7/125

(52) U.S. Cl. 369/53.28; G9B/7.098

(57) ABSTRACT

A method for determining a focus height of an optical disc drive is provided. A disc is placed into the optical disc drive. An objective lens is moved to lock a focus on a data layer of the disc. The objective lens is radially moved from inner tracks to outer tracks, and at the same time the focus voltages at the radial position are recorded. A focus voltage curve is curve-fitted based on the recorded focus voltages. A corresponding refocus voltage is obtained from the focus voltage curve according to the radial position where a focus drop occurs. The objective lens is moved to the focus height by the refocus voltage for refocusing.

This application claims the benefit of Taiwan application Serial No. 98140086, filed Nov. 24, 2009, the subject matter of which is incorporated herein by reference.

### BACKGROUND OF THE INVENTION

1. Field of the Invention

The invention relates in general to an optical disc drive for reading or writing an optical disc, and more particularly to a method for determining focus height when the optical disc drive needs refocus during reading or writing the optical disc.

2. Description of the Related Art

Disc is formed by plastics. During the process of fabrication, transportation or storage, disc may become uneven or warped due to the factors such as material change, non-uniform heating, insufficient cooling, non-uniform coating or uneven pressing, hence negatively affecting read/write of disc data.

As indicated in FIG. 1, during the process of focusing, the conventional optical disc drive drives (moves up or moves down) an objective lens 2 of a pick-up head 1 with an electromagnetic force generated from voltage pulses, for projecting a laser beam onto a data layer 4 of a disc 3. Then, the data layer 4 with a reflective coating reflects the laser beam back to the pick-up head 1 to form a zero-crossing focus error signal to lock the focal point of the laser beam on the data layer 4, so that the optical disc drive can read/write data on the disc 3 along tracks of the data layer 4.

During the read/write process, the optical disc drive may fail to timely fetch the focus error signal due to the collision, vibration, tarnish or servo error, hence resulting in focus drop. Under such circumstance, the optical disc drive needs to be refocused. Since the turntables of the optical disc drives may have different horizontal heights during rotation and the disc 3 is uneven or warped, the focus heights of the data layer 4a are inconsistent. During the process of refocusing, if the focus error signal cannot be fetched in time, the over-lifted objective lens 2 will hit the disc 3 and be damaged or the over-lowered objective lens 2 will hit the pick-up head 1 and be damaged. As disclosed in Taiwanese Patent No. 1303820 entitled “Anti-Scratch Mechanism For Optical Disc Drive”, upper and lower limits ΔV of the focus voltages are for limiting rise and fall of the objective lens 2 to avoid the objective lens 2 hitting or scratching the disc 3.

However, if the disc 3 is over-warped, near the outer tracks of the disc 3, the objective lens 2, subject to the upper/lower movement limits, is unable to reach suitable focus height. Under such circumstance, refocusing is likely to fail, and the read/write of disc data cannot be completed. Furthermore, as for a warped disc, read/write signals are in bad quality, and the disc drive may easily result in focus drop under normal operation parameters and needs to be re-focused. Thus, the read/write efficiency of the optical disc drive is affected. In addition, for each refocusing, the objective lens 2 needs to be gradually lifted/lowered for determining the focus height, and such process is very time-consuming and affects the read/write efficiency of the optical disc drive. Therefore, there are still many problems left to be resolved in determining the focus height during refocusing of the optical disc drive.

### SUMMARY OF THE INVENTION

One object of the invention is directed to a method for determining the focus height of an optical disc drive. Through the establishment of a focus voltage curve, the focus height is determined for promptly refocusing, hence increasing the efficiency of the optical disc drive.

Another object of the present invention is directed to a method for determining the focus height of an optical disc drive. The vertical bias of the disc is determined according to changes in the focus voltages of a focus voltage curve for timely adjusting the operation parameters of the optical disc drive and increasing the success rate of refocusing.

To achieve the above and other objects, the method for determining the focus height of an optical disc drive according to a first exemplary embodiment of the invention includes the following steps. A disc is placed into the optical disc drive. An objective lens is moved to lock a focus on a data layer of the disc. The objective lens is radially moved from inner tracks to outer tracks, and at the same time focus voltages at the radial position are recorded. A focus voltage curve is curve-fitted based on the recorded focus voltages. A corresponding refocus voltage is obtained from the focus voltage curve according to the radial position where a focus drop occurs. The objective lens is moved to the focus height by the refocus voltage for refocusing.

According to a second exemplary embodiment of the present invention, a method for determining the focus height of an optical disc drive is disclosed. A disc is placed into the optical disc drive. An objective lens is moved to lock a focus on a data layer of the disc. The objective lens is radially moved from inner tracks to outer tracks, and at the same time focus voltages at the radial position are recorded. A focus voltage curve is curve-fitted based on the recorded focus voltages. A vertical bias is obtained by comparing the focus voltages at different radial positions. The operation parameters of the optical disc drive are adjusted if the vertical bias is greater than a threshold. A corresponding refocus voltage is obtained from the focus voltage curve according to the radial position where a focus drop occurs. The objective lens is moved to the focus height by the refocus voltage for refocusing.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a conventional refocusing process in a prior optical disc drive;

FIG. 2 shows a process of establishing a focus voltage curve for an optical disc drive according to an embodiment of the invention;

FIG. 3 shows a refocusing process in the optical disc drive according to a first embodiment of the invention;

FIG. 4 shows a method for determining the focus height of the optical disc drive according to the first embodiment of the invention;

FIG. 5 shows a process of checking a vertical bias according to a second embodiment of the invention; and

FIG. 6 shows a method for determining the focus height of the optical disc drive according to the second embodiment of the invention.

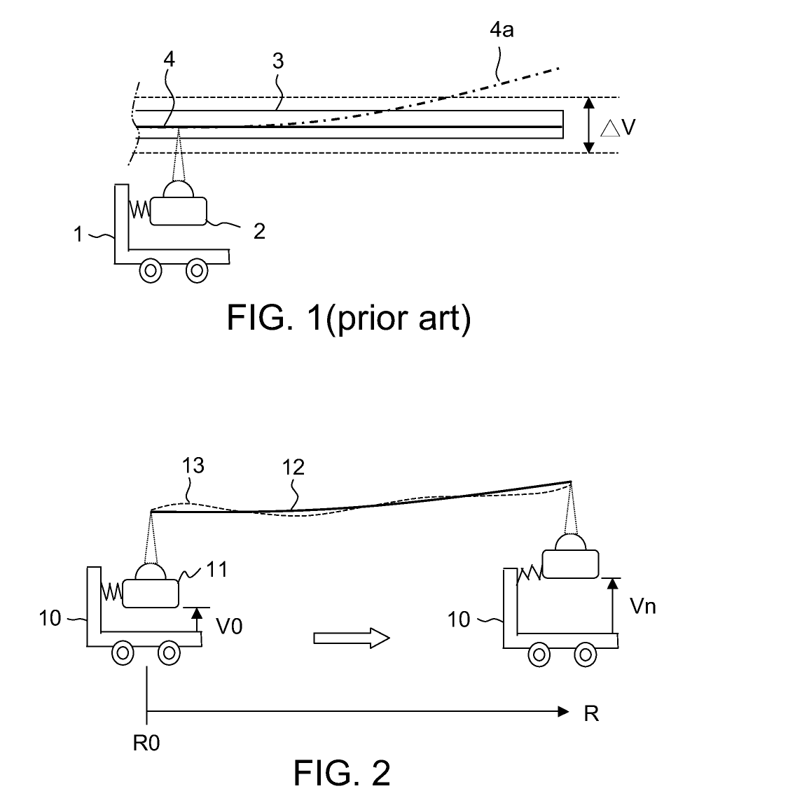

### DETAILED DESCRIPTION OF THE INVENTION

The technologies and their effects adopted in embodiments of the invention for achieving the above objects are disclosed below in a number of embodiments with accompanying drawings.

Referring to FIG. 2, a process of establishing a focus voltage curve for an optical disc drive according to an embodiment of the invention is shown. A pick-up head 10 moves an objective lens 11 with an electromagnetic force which varies with the amount of voltage pulses provided by the pick-up head 10. Therefore, the pick-up head 10 controls the lifting/lowering height of the objective lens 11 with a focus voltage, and there is a ratio between the magnitude of the focus voltage and the focus height of the objective lens 11.

The establishment of the focus voltage curve is as the following. First, a disc is placed into the optical disc drive. The objective lens 11 is pushed up by a focus voltage V. A laser beam is projected on a data layer 12 of the disc and a focus error signal is fetched to lock a focus of the laser beam on the data layer 12. The inner tracks of the disc, close to the part of the disc which is clamped and rotated by the optical disc drive, have smallest warpage, and focusing is easy on the inner tracks of the disc. Therefore, the focus locking is normally performed on the inner tracks of the disc, that is, at the radial position RO. Next, the objective lens 11 is radially moved from inner tracks to outer tracks by the pick-up head 10, and at the same time, the focus voltages V0˜Vn for lifting/lowering the objective lens 11 at each radial position are recorded during focus locking.

In theory, during focus locking, the focal point of the objective lens 11 is moved along the data layer 12, and the focus voltages V0˜Vn correspond to the focus heights of the objective lens 11 relative to the pick-up head 10. Due to the wobbling of the disc caused by the rotation of the disc and due to delay of the servo control of the optical disc drive, the focal point of the objective lens 11 (illustrated as the dotted line 13) slightly fluctuates vertically around the data layer 12. So, approximate focus voltages of the disc can be obtained from the focus voltages V0˜Vn. Thus, a focus voltage curve is curve-fitted based on the recorded focus voltages V0˜Vn at the radial positions.

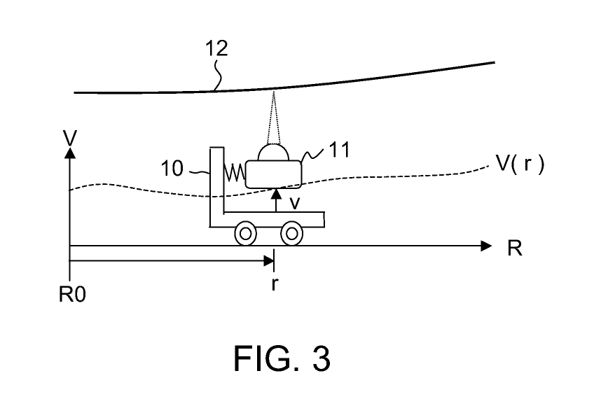

As indicated in FIG. 3, a process of refocusing in an optical disc drive according to a first embodiment of the invention is shown. The focus voltage curve V(r) is established by the optical disc drive as for the inserted disc. When the pick-up head 10 performs read/write of disc data along the radial direction of the disc, if focus drop occurs at a radial position r, the pick-up head 10 can obtain a corresponding refocus voltage v at the radial position r from the pre-established focus voltage curve V(r) according to the radial position r where the focus drop occurs, immediately pushes the objective lens 11 to the focus height (or near the focus height) by the refocus voltage v, and fetches a focus error signal to lock the focus on the data layer 12 for refocusing and restore into the focus servo state to continue the read/write of disc data. In comparison to the conventional method, the method of the first embodiment of the invention is advantaged in that the required time for determining the focus height by lifting/lowering the objective lens is reduced, the restrictions on the limits of lifting/lowering the objective lens are lifted, and refocusing can even be performed on the outer tracks which are more warped.

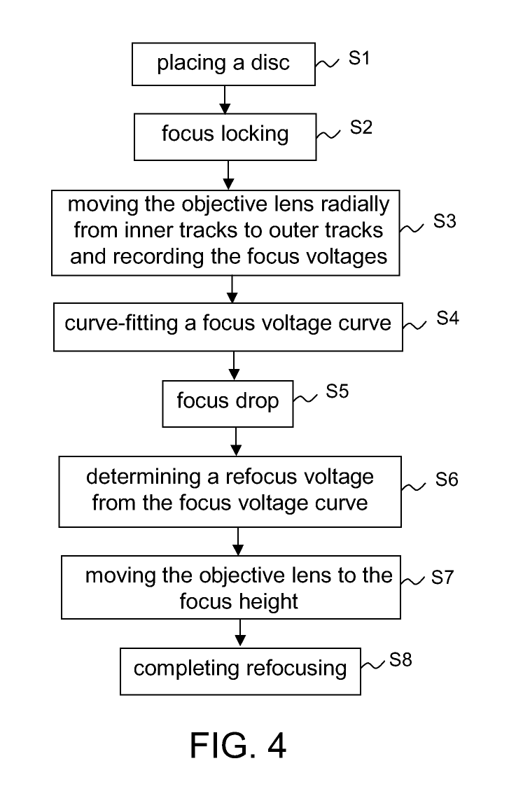

As indicated in FIG. 4, a method for determining the focus height of the optical disc drive according to the first embodiment of the invention is shown. The steps of determining the focus height on the basis of the pre-established focus voltage curve according to the method of the first embodiment of the invention are disclosed below. Firstly, at step S1, the disc is placed into the optical disc drive. Next, at step S2, the objective lens is pushed by the focus voltage, and the laser beam is projected on the data layer of the disc to lock the focus on the data layer. Then, at step S3, during the focus locking, the objective lens is radially moved from inner tracks to outer tracks, and during the movement of the objective lens, the focus voltages at respective radial positions for lifting/lowering the objective lens are recorded. After that, at step S4, the focus voltage curve is fitted based on the recorded focus voltages at respective radial positions.

Afterwards, at step S5, refocusing is performed when the focus drop occurs during the read/write of disc data. Then, at step S6, a corresponding refocus voltage related to the radial position (where the focus drop occurs) is obtained from the focus voltage curve according to the radial position. Then, at step S7, the objective lens is lifted/lowered to the focus height by the refocus voltage. Lastly, at step S8, a focus error signal is fetched for refocusing.

According to the method for determining the focus height of the optical disc drive disclosed in the first embodiment of the invention, after the disc is placed into the optical disc drive, the optical disc drive moves the objective lens from inner tracks to outer tracks to lock the focus, and records the focus voltages at respective radial positions, so as to establish the focus voltage curve with respect to the warpage of the disc. When the focus drop occurs, the focus height is obtained from the focus voltage curve according to the radial position where the focus drop occurs, for refocusing in response to the diversity in different optical disc drives and the warp of the disc, hence increasing the performance of the optical disc drive.

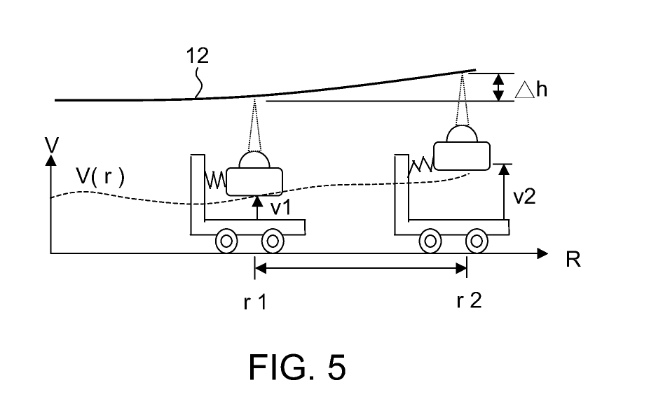

As indicated in FIG. 5, a process of checking a vertical bias according to a second embodiment of the invention is shown. The second embodiment of the invention uses the focus voltage curve V(r) established in the first embodiment. The focus voltages between the radial positions r1 and r2 are compared, and the vertical bias Δh of the disc between the radial positions r1 and r2 is obtained from the difference (v2−v1) for determining the warped degree of the data layer 12 of the disc. Then, an acceptable vertical bias threshold H is set. When the vertical bias Δh at the warped part exceeds the threshold H, the operation parameters of the optical disc drive are adjusted as having higher tolerance. If the focus drop occurs at the warped part, the focus height is quickly obtained from the focus voltage curve for refocusing and for performing normal read/write on the disc with abnormal warpage.

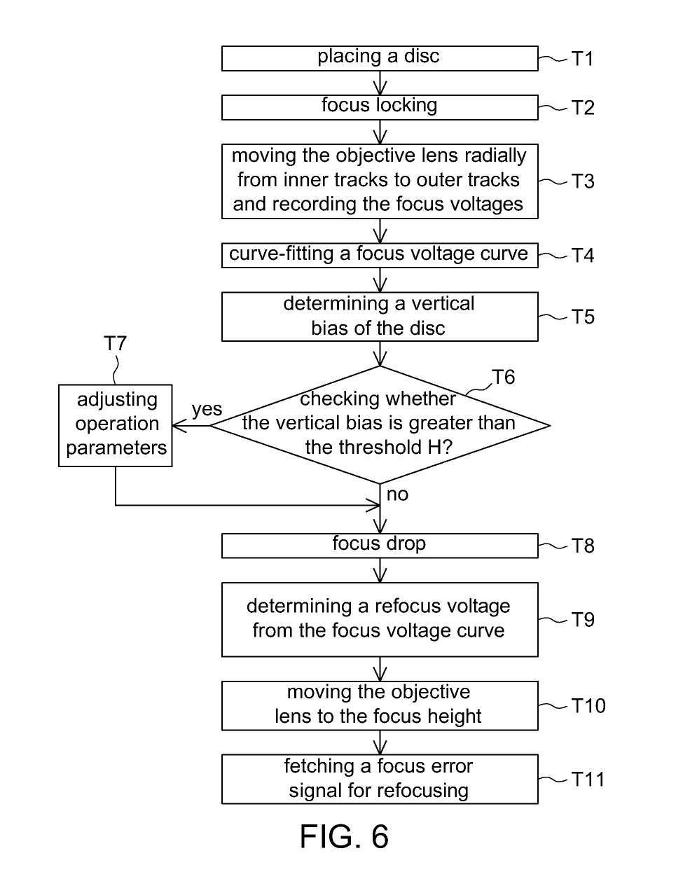

As indicated in FIG. 6, a method for determining the focus height of the optical disc drive according to the second embodiment of the invention is shown. The details of the present embodiment of the invention are disclosed below. Firstly, at step T1, the disc is placed into the optical disc drive. Next, at step T2, the objective lens is moved to lock the focus on the data layer. Then, at step T3, during the focus is locked, the objective lens is radially moved from inner tracks to outer tracks, and during the movement of the objective lens, the focus voltages at respective radial positions for lifting/lowering the objective lens are recorded. After that, at step T4, the focus voltage curve is curve-fitted based on the recorded focus voltages. Afterwards, at step T5, the vertical bias of the disc is obtained from the focus voltage curve by comparing the focus voltages at different radial positions.

Then, at step T6, whether the vertical bias is greater than the threshold H is checked. If the vertical bias is greater than the threshold H, then the method proceeds to step T7 to adjust the operation parameters of the optical disc drive as having higher tolerance and then the method proceeds to step T8. If the vertical bias is not greater than the threshold H, then the method proceeds to step T8 from the step T6. At step T8, refocusing is performed when focus drop occurs during the read/write of disc data. At step T9, a corresponding refocus voltage related to the radial position (where the focus drop occurs) is obtained from the focus voltage curve according to the radial position where the focus drop occurs. Then, at step T10, the objective lens is lifted/lowered to the focus height based on the refocus voltage. Lastly, at step T11, the focus error signal is fetched for refocusing.

According to the method for determining the focus height of the optical disc drive disclosed in the second embodiment of the invention, the vertical bias of the disc is obtained from the focus voltage curve by comparing changes in the focus voltages at different radial positions for timely adjusting the operation parameters of the optical disc drive. Thus, if the focus drop occurs, the focus height is quickly obtained from the focus voltage curve according to the radial position where the focus drop occurs, for refocusing the disc with abnormal warpage and increasing the success rate of refocusing.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for determining a focus height of an optical disc drive, comprising:
(1) placing a disc into the optical disc drive;
(2) moving an objective lens to lock a focus on a data layer of the disc;
(3) moving the objective lens radially from inner tracks to outer tracks of the disc and during movement of the object lens, recording focus voltages at radial positions;
(4) curve-fitting a focus voltage curve based on the recorded focus voltages; and
(5) obtaining a corresponding refocus voltage from the focus voltage curve for refocusing.

2. The method for determining the focus height of the optical disc drive according to claim 1, wherein in the step (2), the focus is locked on the inner tracks of the disc.

3. The method for determining the focus height of the optical disc drive according to claim 1, wherein in the step (5), refocusing is performed if a focus drop occurs during read/write of disc data.

4. The method for determining the focus height of the optical disc drive according to claim 3, wherein the corresponding refocus voltage is obtained from the focus voltage curve according to the radial position where the focus drop occurs.

5. The method for determining the focus height of the optical disc drive according to claim 4, wherein the objective lens is moved to the focus height by the refocus voltage.

6. A method for determining a focus height of an optical disc drive, comprising:
(1) placing a disc into the optical disc drive;
(2) moving an objective lens to lock a focus on a data layer of the disc;
(3) radially moving the objective lens from inner tracks to outer tracks of the disc and during movement of the objective lens, recording focus voltages at respective radial positions;
(4) curve-fitting a focus voltage curve based on the recorded focus voltages;
(5) obtaining a vertical bias by comparing the focus voltages at different radial positions;
(6) checking whether the vertical bias is greater than a threshold H, if yes, adjusting operation parameters of the optical disc drive and proceeding to a next step, otherwise, proceeding to the next step;
(7) according to the radial position where a focus drop occurs, obtaining a corresponding refocus voltage from the focus voltage curve; and
(8) moving the objective lens to the focus height by the refocus voltage for refocusing.

7. The method for determining the focus height of the optical disc drive according to claim 6, wherein in the step (2), the focus is locked on the inner tracks of the disc.

8. The method for determining the focus height of the optical disc drive according to claim 6, wherein in the step (7), refocusing is performed if focus drop occurs during read/write of disc data.
